(19) United States
(12) Patent Application Publication
(10) Pub. No.: US 2007/0297109 A9
(43) Pub. Date: Dec. 27, 2007

(54) SYSTEM AND METHOD FOR PROTECTING AGAINST SHORT CIRCUITS IN ELECTRIC POWER DISTRIBUTION ARCHITECTURES WITH TWO VOLTAGE LEVELS

(75) Inventors: Carles Borrego Bel, Valls (ES); Joan Fontanilles Pinas, Valls (ES)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/709,677

(22) Filed: May 21, 2004

Related U.S. Application Data
(63) Continuation of application No. PCT/ES2001/000462, filed on Nov. 27, 2001.

(51) Int. Cl. H02H 3/00

(52) U.S. Cl. 361/62

(57) ABSTRACT

A protection system and method against short-circuits in electric power distribution architectures at two voltage levels, with a battery B1 and a second battery B2 at a higher voltage level, provided with automatic disconnection means SDB, and for differentiated supply of electric power to network sectors provided with power distribution units (10), (20), (30) to loads (12), (22), (23), (32), (33), said units (10), (20), (30) including a microcontroller (10a), (20a), (30a), said first battery B1 and sector or sectors it feeds being susceptible of being fed from the second battery B2, connected to a voltage generator by a converter DC/DC, comprising monitoring the voltage and current at the posts of said battery B1 and the state of the converter DC/DC, and if said state goes on to become a predetermined one and, then, said voltage and current levels exceed a threshold, microcontrollers (10a, 20a, 30a) are informed by a communications network N to carry out a short-circuit protection process.

### BACKGROUND OF INVENTION

1. Field of the Invention

The present invention refers to a protection system against short-circuits in an electric power distribution architecture comprising at least a first battery B1 at a first voltage level, and a second battery B2 at a second, higher voltage level. Both batteries B1 and B2 or voltage sources, are provided with an automatic disconnection device and intended for a differentiated electric power supply to respective network sectors provided with corresponding power distribution units to the loads, each one controlled by a respective microcontroller, said first battery B1 and sector or sectors it supplies being susceptible of being supplied in turn from the second battery B2 at a higher voltage level, through a converter DC/DC, said battery B2 being connected to a voltage generator. Said converter can be a one-way or a two-way converter.

The invention is applicable to electric power distribution networks and/or architectures with parts or sectors at two voltage levels, in particular, used in the automotive field, known as “dual voltage” and hereinafter referred to as DV.

The invention also refers to a method for implementing said system, comprising a series of protection processes against short-circuits carried out by said power distribution units, operating in a controlled manner and generally controlled from a centralized, short-circuit detecting center. Said short-circuit protection procedures essentially comprise a detection process by means of an action on the different network loads, especially on those power loads susceptible of being involved in the short-circuit situation.

Additionally, the invention falls within the electric power distribution architectures implemented on the basis of power sectorisation, according to which principle they are defined in the network, e.g. a series of areas installed in a vehicle, existing in each one of them an intelligent node (power distribution unit or box with a management microcontroller) that locally controls the loads and switches, protection devices and/or sensors associated to the same, which intelligent nodes are adapted to send and receive information through a multiplexed data bus, which allows for a great reduction not only of the number of cables but also in their length, not forgetting the decrease in the number of cables that go from one area to another of the vehicle, the parameter of which has great influence in the ease of assembly of the wiring and in minimizing the risk of short-circuits due to the applied physical protections.

2. Background of the Invention

DV systems and particularly those implemented in vehicles, typically comprise a first network at 14V used to feed low demand loads, supplied from a battery B1 or from a second network at a higher voltage, typically 42V, through a one-way or two-way electrical converter DC/DC. On its part, said second 42V network is used to feed high demand loads such as the starter, the heating system, the electromagnetic valve control, motors, such as those of the window opening mechanisms, position adjustment, fans, etc., and is fed from a generator G (the vehicle's alternator) or from a second battery B2.

DV systems particularly for vehicles are described in numerous patent and patent application documents, it being possible to mention the following ones: U.S. Pat. No. 5,334,926, U.S. Pat. No. 6,232,674, EP 337155, EP 539982, EP 1033804, WO 99/22434 and WO 00/76812.

Due to the coexistence of both power networks at different voltage levels, a new problem related to the safety of the system is added with regards to the usual positive grounding short-circuits. Said problem relates to the possibility that, in the automobile sector example explained, some eventual short-circuits between the +14V and +42V positives occur. The traditional protection approaches applied to date cannot totally ensure safety in DV architectures, wherein consequences can be much more dangerous, with the risk of explosion of battery B1 at a lower voltage level and/or of fire in part of the affected network, susceptible of propagating.

There are essentially two types of protection against short-circuits in DV architectures. The first and more economic one is mechanical, affecting the protection of the wiring, of the network itself, and its design and routing. The mechanical isolation can thus be intensified in the scope of the components (fuses near the batteries, arrangement of the two batteries at spaced points, differentiated and sealed connectors, lids for threaded terminals, etc.) and, with regard to the distribution lines themselves, a suitable dimensioning of the cables and a suitable isolation between themselves and, in the case of the automobile, a separation of the spans at different voltage levels, especially of those areas susceptible of receiving an impact by e.g. a shock, can be proceeded with.

The second class of protection is active (electrical) y it is based in some current measurements at different points of the network that allow for sensing when a fault occurs. The invention falls within this second field and has the advantage of using some electronic modules, mainly associated to the battery at a lower voltage level, having an important role because controls all services to the network at a higher voltage level (in the referred example, the one at 42V) and establishes communication with the rest of the system to receive/send some suitable parameters related to some potential short-circuit situations.

Patent application PCT ES00/00393, from the applicant itself, discloses a modular assembly connectable to a battery, for supervision of its state and protection, including a series of electronic modules comprising a first module BD applied to a disconnection of the power supply from said battery, a second module BM applied to a dynamic measure of the states of charge (SOC) and health (SOH) of the battery, according to the technology disclosed in the Spanish patent application P 200003143, also from the applicant itself, based on determining the electrochemical impedance of the battery, and a third module LCM destined to a control and management of the loads fed by said battery. But said modular assembly is not equipped nor provided for the methodology shown in this invention.

Other documents of interest with regard with the field of the invention are patents U.S. Pat. No. 1,592,57, U.S. Pat. No. 6,281,631 and WO 98/54811.

### BRIEF DISCLOSURE OF THE INVENTION

During a short-circuit between power supply sources or batteries, current flows from battery B2 at a higher voltage level to battery B1 through the path of the short-circuit. The resistance of the cables involved is usually between 50 mOhm and 300 mOhm, so that the currents may range between 480 A and 80 A (being possible even lower currents, depending on the physical elements involved in parallel). This overcurrent can blow some of the fuses, so that it is possible that the short-circuit then disappears or that it may burn the cables or even that it may cause the explosion of the lower-voltage-level battery B1.

The required steps for identification of a short-circuit avoiding confusion with an overcurrent of another nature, according to the invention, are the following: 1) alarm derived from the state of the converter DC/DC; 2) constant sensing of the voltage at posts of the lower-voltage-level battery B1; 3) changes of current in the lower-voltage-level battery B1.

All the above conditions must be met and the order or sequence thereof is mandatory in order to achieve the minimum and necessary conditions for identifying a short-circuit.

According to the typical structure and functionality, a converter DC/DC stops the conversion process in case voltage at the input and the output thereof are outside a certain, pre-set range. The converter constantly detects (by means of analog wiring during at least 2 ms) for the voltage at the input to be in the range of 30 to 58 V (specification for the voltage of the 42V power source) and that the output is between 9V and 21V (suggested voltage for the specification of the 14V power source). A module SMM in charge of short-circuit monitoring, preferably associated to a battery B1 at the lower voltage level, will be advantageously informed by a direct connection (in order to avoid delays derived from a shared communications network) about said abnormal situation. A specific voltage detector for the power supply source B2 at the higher voltage level is not considered necessary due to the use of said feature of the converter DC/DC.

Once by means of the information given by the converter DC/DC, it is known that an alteration in the voltage values in both power supply sources has occurred, sensing of a redundant voltage, as close as possible to the power supply source B1 at the lower voltage level, during a specified time that clearly identifies a constant overcurrent situation, is proposed. Knowledge of the loads is necessary to determine this time (a time of around 1 ms is suggested). Said module SMM will check this information and complete the short-circuit sensing process.

If the converter DC/DC is disconnected, it is not possible that charging from the power supply source or battery B1 at low voltage level occurs. Therefore, if said module SMM senses a change of current in the load of said power supply source B1, this is a clear indication that a short-circuit has been established (the accuracy in the sensing of this current is not important since it is enough to verify that a certain degree of current charging the source exists).

If all the above conditions have been sensed by the SMM, then it is proceeded to inform the microcontrollers of the different power distribution units of the architecture about it (by means of e.g. sending a priority interruption) so that they perform a short-circuit protection that essentially will comprise disconnecting the power loads and/or an inspection thereof disconnecting those that show anomalies, and eventually disconnecting battery B2 at the higher voltage level, and even battery B1.

The invention will be described below as well as diverse variants of the referred short-circuit protection process, with greater detail, with reference to some drawings illustrative of a way of implementing it, provided by way of example only.

### BRIEF DESCRIPTION OF DRAWINGS

FIG. 1 is a schematic diagram of the operative principles proposed by the invention, showing in addition those basic parts of the system and method, i.e. the converter DC/DC, batteries B1, B2, generator G, short-circuit monitoring module SMM, power distribution units PDU, and communications network N.

FIG. 2 is a representation, likewise simplified, that shows a power distribution system comprising two batteries B1, B2 and three power distribution units or boxes, situated in different areas, e.g. in the front portion FPDU, in the rear portion RPDU, and in the middle portion MPDU of an automotive vehicle. The first two ones include a first part that governs power loads and a second part intended for loads fed from the network at a lower voltage level, whilst the third one is only provided for loads at the lower voltage level. Each one of the energy distribution boxes comprises a control microcontroller.

### DETAILED DESCRIPTION

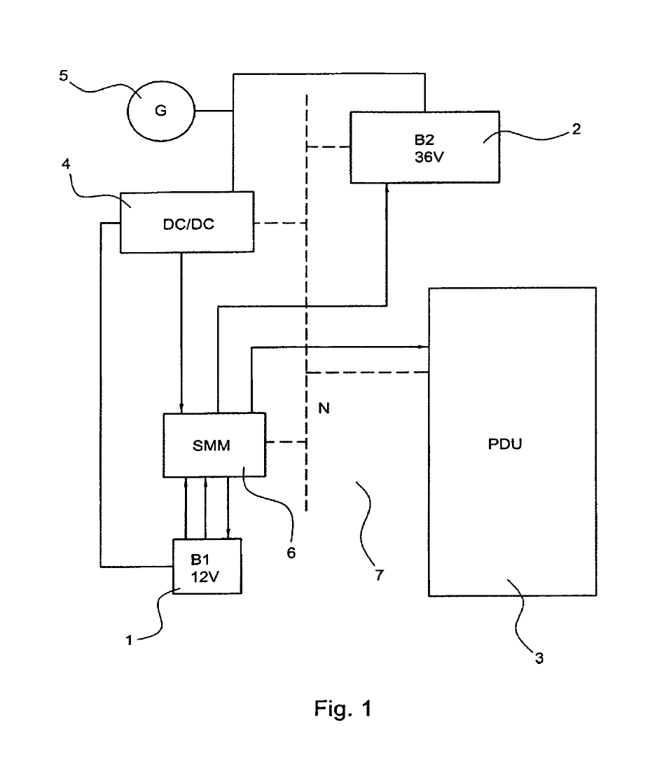

FIG. 1 shows an electric power distribution architecture at two voltage levels, comprising at least a first battery B1 at a first 12V voltage level and a second battery B2 at a second, higher 36V voltage level, both provided with an automatic disconnection device and intended for differentiated supply of electric power to respective network sectors provided with units for distributing power to the loads, which units are schematized by a single PDU unit or assembly, controlled by a corresponding microcontroller. As can be seen, said first battery B1 and sector or sectors it supplies can be fed in turn from the second battery B2 through a converter DC/DC, whilst the second battery B2 and network at a higher voltage level are connected to a voltage generator G, such as e.g. an automobile's alternator.

According to the invention, said first, lower-voltage-level battery B1 has a module SMM associated to it, based on a microcontroller applied to monitoring the voltage and current (essentially, the direction of the current) at the posts of this battery B1 and to permanently sensing a state of operation of the converter DC/DC. On the other hand, said monitoring module of battery B1 in turn is connected, through a port of its micro-controller and a communications network N, to each one of the control microcontrollers of the power distribution units to the loads in order to, facing a short-circuit situation sensed by said monitoring module based on some sensed, predetermined values of voltage, current, and state of the converter DC/DC, inform to each one of the microcontrollers of said power distribution units so that they perform a short-circuit protection process.

Input arrows to module SMM indicate information that it permanently monitors for: state of the converter DC/DC, voltage at posts of battery B1, and eventual load current to said battery B1 at a lower voltage level. On the other hand, communications network N, depicted by dashed lines, indicates intercommunication between said module SMM and converter DC/DC, batteries B1, B2, and power distribution units PDU. Output arrows from module SMM indicate information and/or commands that said module sends to the microcontrollers in charge of the PDUs, as well as the eventual disconnection commands to batteries B2 and even B1.

Said short-circuit protection process comprises several action alternatives to be performed on the part of the power distribution units once module SMM has sent an interruption to the microcontroller of the corresponding unit, basically consisting in a disconnection of the charges and/or check/inspection thereof, after execution of which, and if the short-circuit situation persists, said module SMM may order the disconnection of battery B1 and even of battery B2.

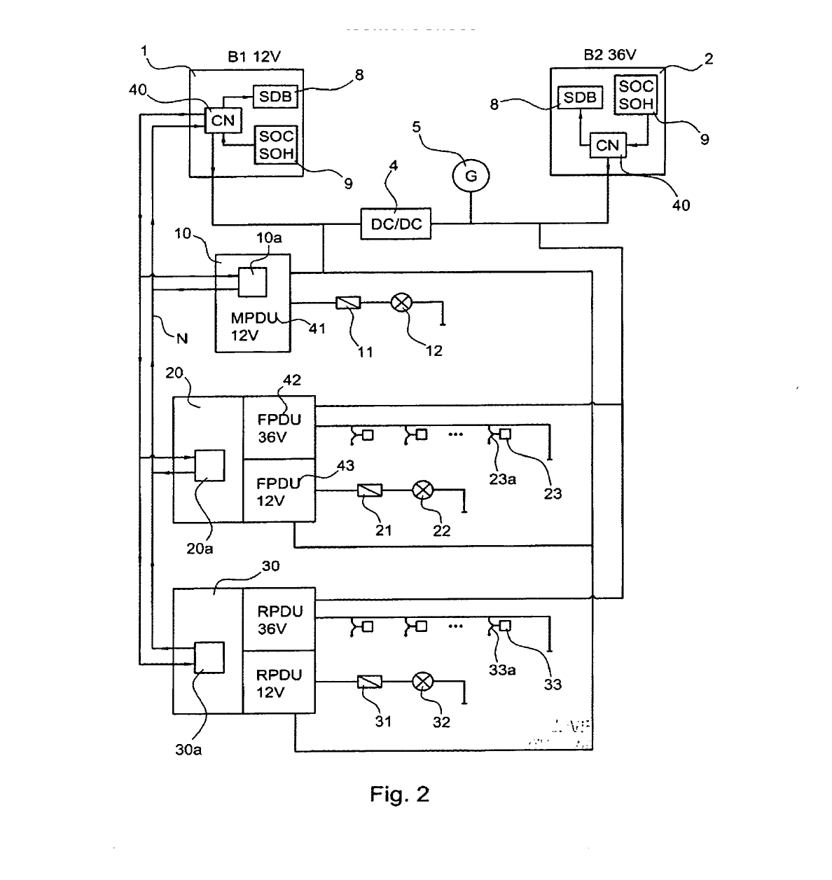

The method of the present invention, which is applied by means of the system described in relation to FIG. 1, is described in relation with the example illustrated in FIG. 2.

Thus, the first battery B1 at a first 12V voltage level and the second battery B2 at a second 36V voltage level are shown in FIG. 2. In this example, both batteries B1 and B2 are provided with a corresponding automatic disconnection device SDB, a monitoring module of the state of charge SOC and of the state of health SOH, and a control node CN. Each battery B1, B2 is intended for a differentiated supply of electric power to respective network sectors provided with power distribution units 10, 20, 30 to the loads. First battery B1 and sector or sectors it feeds, is susceptible of being fed in turn from second battery B2 through a converter DC/DC, whilst battery B2 is connected to a voltage generator G, such as the vehicle's alternator. Control node CN associated to battery B1 takes on, in FIG. 2, the functions of said module SMM applied to sensing the operative state of said converter DC/DC and to subsequent monitoring in case said state is a stoppage of the conversion process of the voltage and current at the posts of said battery B1.

Each power distribution unit 10, 20, 30 is controlled by a corresponding microcontroller 10a, 20a, 30a. In the illustrated example, distribution unit 10 has just one sector MPDU dedicated to the loads situated in the middle portion of an automotive vehicle, which are at 14V and have been symbolized as a lamp 12 protected by a fuse 11. Instead, distribution units 20 and 30, which are respectively intended for the loads in the front and rear portions of the automobile, have each one a respective sector FPDU, RPDU provided for feeding the loads at 14V, symbolized by lamps 22, 32 protected by respective fuses 21, 31, and a respective sector FPDU, RPDU for feeding the loads 23, 33 at 42V which have associated corresponding power switches 23a, 33a for controlling said loads, such as either FET power switches with current sensing or power relays.

Communications of control node CN of battery B1, representative of short-circuit monitoring module SMM, with node CN of second battery B2 and with the different microcontrollers 10a, 20a, 30a of the power distribution units 10, 20, 30 are preferably carried out through a dedicated network N, although a shared bus, such as a CAN bus, may be likewise used.

The method according to the invention basically comprises performing a permanent monitoring of the state of converter DC/DC that interrelates said two batteries B1 and B2, as well as at least the voltage and/or current at the posts of said battery B1. In case of sensing a stoppage of the conversion process of the converter DC/DC, and after this, it occurs that said voltage value exceeds a certain threshold, and that said current is an input current to battery B1, node CN informs immediately through said dedicated communications network N or CAN bus to each one of the microcontrollers 10a, 20a, 30a of said power distribution units 10, 20, 30 so that they perform a short-circuit protection process.

Thus, the method's initial step comprises proceeding, in an ordered and sequential manner, in the sensing of the condition of the converter DC/DC, acquiring the voltage at the posts of the 12V battery B1 and, finally, sensing a possible load current of said battery B1 and, only if the predetermined values of said two voltage and current measurements (in this last case, basically sensing an input or load current of battery B1) fall within some pre-set ranges, proceeding to inform the power distribution units of an eventual short-circuit situation by sending an interruption to the corresponding microcontrollers 10a, 20a, 30a so as to initiate a short-circuit protection algorithm or process.

According to a first variant, a short-circuit protection process to be carried out by the power distribution units, essentially those 20, 30 which have associated power loads 23, 33, when their microcontrollers 20a, 30a receive said interruption, comprises a total disconnection of all said power loads 23, 33 and, in case a short-circuit situation continues being sensed (by assessment of three previously mentioned conditions) from said monitoring module or node CN of battery B1, sending a signal through said communications network N for disconnection of at least the battery B2 of higher voltage level (36V) is proceeded with, accessing the disconnection device SDB of said battery B2 or the microcontroller of the control node CN associated with said battery B2.

In the event that said complete disconnection of the loads leads to a non-short-circuit situation, as evaluated by said monitoring module, then a one-at-a-time reconnection of power loads 23, 33 of each power distribution unit 20, 30 is proceeded with until sensing of the load or loads susceptible of generating said short-circuit situation, as evaluated by said monitoring module, the load of which is disabled until its repair or substitution.

However, as an option, prior to performing reconnection of each one of said power loads, it is possible to perform a prior step consisting of a voltage or impedance measurement at the output of each power switch 23a, 33a applied to controlling the respective load, and in case the measured values exceed a certain threshold, said charge is left inactive.

The short-circuit protection process of the present invention comprises, according to another variant, progressively disconnecting all power loads 23, 33 associated to each one of the power distribution units 20, 30, and checking from said monitoring module or node CN of battery B1 if a certain disconnection makes the short-circuit situation stop. If that is the case, disconnection of the involved load is proceeded with. If at completion of the disconnection of all the power loads 23, 33 of each power distribution unit 20, 30 a short-circuit situation continues being sensed from said node CN of the monitoring module, a signal for disconnecting at least higher-voltage-level battery B2 is sent through said communications network N, accessing in order to doing so disconnection device SBD of said battery B2 or the microcontroller of a control node CN associated with said battery B2.

Still another different possibility for the short-circuit protection process of the present invention comprises supervising current demand of some controlling devices, such as a power switch 23a, 33a, associated to each one of the power charges 23, 33 dependent on each one of the power distribution units 20, 30, and disconnecting those loads in which said demand exceeds a certain threshold and, then, in case a short-circuit situation continues being sensed from said monitoring module, after completion of the supervision of all the power loads of each power distribution unit, a signal for disconnecting at least higher-voltage-level battery B2 is sent through said communications network N, accessing in order to doing so the disconnection device SDB of said battery B2 or the microcontroller of a control node CN associated with said battery B2.

Given that power distribution units 10, 20, 30 comprise some devices such as some switches 23a, 33a with current sensing, associated with each one of the power loads 23, 33, the power switches 23a, 33a of which are controlled from the corresponding microcontroller 20a, 30a of the corresponding unit 20, 30, the invention proposes in an initial phase and prior to proceeding with the disconnection of the power loads, a prior phase of sensing of the output state of each one of said switches 23a, 33a, particularly their voltage or impedance, so that if the sensed value in a certain power switch 23a, 33a exceeds a certain threshold, connection of the load associated therewith is not proceeded with anymore. E.g. in case a short-circuit between the 42V load and a 14V circuit exists, the output voltage of the corresponding FET associated to said load will be 14V instead of OV (ground). Thereby, prior to connecting this load, the system may be informed of a potential short-circuit that could damage the power distribution system. This sensing only verifies circuits fed at 14V. This solution is easily implemented and the accuracy of said measurement might be of 10% because the mere sensing of the existence of a voltage is a clear indication of a possible fault in the circuit. In the event that the circuit associated to the 14V load is disconnected, sensing of a voltage level would not avoid the short-circuit. Therefore, characterization of the impedance of the loads is proposed, so that prior to connection of the load, an out-of-range impedance could be sensed, indicative of a short-circuit risk.

As indicated, whichever the action variant chosen, if after the execution of said short-circuit protection process by each one of said power distribution units 20, 30 in relation with the power loads 23, 33 involved, node CN of the monitoring module associated with battery B1 continues sensing a short-circuit situation, disconnection of battery B2 or even battery B1 from their corresponding sectors of the network they feed is proceeded with.

As for the latency (time period from sensing until solving a short-circuit event) of the proposed action, the different steps of the method have to be considered: 1) sensing: information about a state of stoppage of the converter DC/DC, together with the acquisition of the voltage and current values at the posts of battery B1, can take less than 2 ms, and generating, from the microcontroller of the node CN of said battery B1, an interruption to the microcontrollers 10a, 20a, 30a of the power distribution units can last approximately 500 μs. Therefore, time of sensing may be close to 2.5 ms; 2) execution of an algorithm of sensing of the load involved or causing the short-circuit situation, by each one of the power distribution units or boxes 10a, 20a, 30a, basically depends on the programming of the interruption in the respective microcontroller 10a, 20a, 30a and on the circuits of the FET devices 23a, 33a with current sensing, being able to estimate it between 250 μs and 500 μs; and 3) disconnection of the FET devices 23a, 33a, around 500 μs (depending on the FET power transistor used).

Thus, the time of latency will be in the range of 4 ms, at worst below 10 ms, which is a time that allows to avoid burning of the cables or fuses.

1. A system for protection against short-circuits in electric power distribution architectures at two voltage levels, comprising at least a first battery B1 at a first voltage level and a second battery B2 at second, higher voltage level, both provided with an automatic disconnection device SDB and intended for a differentiated electric power supply to respective network sectors provided with power distribution units (10), (20), (30) to the loads (12), (22), (23), (32), (33), each one of the units (10), (20), (30) being controlled by a corresponding microcontroller (10a), (20a), (30a), said at least first battery B1 and sector or sectors that it supplies being susceptible of being fed in turn from the second battery B2 through a converter DC/DC, said battery B2 being connected to a voltage generator, characterized in that said first battery B1, at a lower voltage level, has an associated module SMM associated based on a microcontroller applied to monitoring at least the voltage and current at the posts of said battery B1 and to sensing an operating state of said converter DC/DC, which monitoring module of battery B1 is connected through a port of its microcontroller and a communications network N with each one of control microcontrollers (10a), (20a), (30a) of the power distribution units (10), (20), (30) to the loads (12), (22), (23), (32), (33), in order to, facing a short-circuit situation sensed by said monitoring module SMM, according to the detection of a predetermined state of the converter DC/DC, followed by some predetermined, sensed voltage and current values, inform each one of the microcontrollers (10a), (20a), (30a) of said power distribution units (10), (20), (30) in order to carry out a short-circuit protection process.

2. A system according to claim 1, characterized in that said communications network N is a dedicated network that links the microcontrollers (10a, 20a, 30a) of said power distribution units (10, 20, 30) or peripheral units thereof.

3. A system according to claim 1, characterized in that said communications network N is a shared bus, such as a CAN bus, that links the microcontrollers (10a, 20a, 30a) of said power distribution units (10, 20, 30) or peripheral units thereof.

4. A system according to claim 1, characterized in that said monitoring module SMM based on a microcontroller or control node CN is included in an assembly applied to the dynamical measurement of the state of health (SOH) and state of charge (SOC) of said battery B1.

5. A system according to claim 1, characterized in that said monitoring module SMM based on a microcontroller or control node CN is included in an assembly applied to the control and management of all or part of the loads fed by said battery B1.

6. A system according to claim 1, characterized in that said power distribution units (10), (20), (30) to the loads (12), (22), (23), (32), (33) controlled by a microcontroller (10a), (20a), (30a), comprise a portion that supplies loads (22), (32) of said sector, at a lower voltage level, fed from battery B1, and a portion dedicated to said power loads (23), (33) included in said higher-voltage-level sector fed by said battery B2.

7. A system according to claim 6, characterized in that said power loads (23), (33) are governed from devices such as power switches (23a, 33a) with current sensing, the power switches (23a), (33a) of which are controlled from the corresponding microcontroller (20a, 30a) of the unit.

8. A system according to claim 7, characterized in that said power switches (23a), (33a) are FET devices with current sensing.

9. A system according to claim 1, characterized in that each one of said batteries B1 and B2 is provided with an electronic control module based on a microcontroller for controlling at least a disconnection device (SDB) of said batteries.

10. A system according to claim 7, characterized in that said power distribution units (10), (20), (30) comprise a connection of each one of said power switches (23a), (33a) to said microcontroller (20a), (30a) of the corresponding unit (20, 30) for a prior sensing of the voltage or impedance at the output of said power switches (23a), (33a) prior to connecting the controlled load (23), (33), allowing avoidance of said connection if said values are outside of some predetermined margins.

11. A method for protection against short-circuits in electric power distribution architectures at two voltage levels, comprising at least a first battery B1 at a first voltage level and a second battery B2 at a second, higher voltage level, both provided with an automatic disconnection device SDB and destined to a differentiated supply of electric power to respective network sectors provided with power distribution units (10), (20), (30) to loads (12), (22), (23), (32), (33), each one of said units (10), (20), (30) being controlled by a corresponding microcontroller (10a), (20a), (30a), said at least first battery B1 and sector or sectors it supplies being susceptible of being fed in turn from the second battery B1 through a converter DC/DC, said battery B2 being connected to a voltage generator, characterized by performing permanent monitoring of at least the voltage and current at the posts of said battery B1, at a lower voltage level, as well as of the state of the converter DC/DC which interrelates said two batteries B1 and B2, and in that, in case it is sensed that said state of the converter DC/DC goes on to become a predetermined one, and after this said voltage and current values exceed a certain threshold, each one of the microcontrollers (10a, 20a, 30a) of said power distribution units is informed through a communications network N so as to perform a short-circuit protection process.

12. A method according to claim 11, characterized in that during the short-circuit sensing step, sensing of a stoppage state of the conversion process of the converter DC/DC, acquisition of voltage at the posts of battery B1, at a lower voltage level, and finally sensing of a possible load current of said battery B1 are performed in an ordered and sequential manner, so as to, if the predetermined values fall within pre-set ranges, proceed inform to power distribution units (10, 20, 30) about an eventual short-circuit situation, by sending a priority interruption through said network N to the microcontrollers (10a, 20a, 30a) thereof.

13. A method according to claim 11, characterized in that said short-circuit protection process comprises a complete disconnection of all the power loads (23, 33) associated to each one of the power distribution units (20), (30), and in that, in case a short-circuit situation continues being sensed from said monitoring module, a signal is sent through said communications network N for disconnection of at least the higher-voltage-level battery B2, accessing in order to do so the disconnection device SDB of said battery B2 or a control node CN associated to said battery B2.

14. A method according to claim 11, characterized in that in case said complete disconnection of loads (23, 33) leads to a non-short-circuit situation, as evaluated by said monitoring module, a reconnection of the power loads (23), (33) of each power distribution unit (20, 30) is performed until sensing the load or loads susceptible of generating said short-circuit situation, as evaluated by said monitoring module.

15. A method according to claim 14, characterized in that prior to performing the reconnection of each one of said power loads (23), (33), a measurement of the voltage or impedance at the output of a power switch (23a), (33a), applied to controlling a corresponding load (23), (33), is performed, and in that in case the measured values exceed a certain threshold, the involved load is left inactive.

16. A method according to claim 11, characterized in that said short-circuit protection process comprises progressively disconnecting all the power loads (23), (33) associated to each one of the power distribution units (20), (30), and checking, from said monitoring module, if a certain disconnection makes the short-circuit situation stop, in which case a permanent disconnection of the load involved is carried out, and in that in case a short-circuit situation continues being sensed from said monitoring module, after disconnection of all the power loads (23), (33) of each power distribution unit (20), (30), a signal for disconnection of at least higher-voltage-level battery B2 is sent through said communications network N, accessing in order to do so disconnection device SDB of said battery B2 or a control node CN thereof associated to said battery B2.

17. A method according to claim 11, characterized in that said short-circuit protection process comprises supervising of current demand in controlling devices, such as a power switch (23a), (33a), associated to each one of the power loads (23), (33) depending from each one of the power distribution units (20), (30), and disconnecting those loads wherein said demand exceeds a certain threshold, and in that, in case a short-circuit situation continues being sensed from said monitoring module, after the supervision of all the power loads (23), (33) of each power distribution unit (20), (30), a signal for disconnecting at least the higher-voltage-level battery B2 is sent through said communications network N, accessing in order to do so the disconnection device SDB of said battery B2 or a control node CN thereof associated to said battery B2.

18. A method according to claim 11, characterized in that said power distribution units (20), (30) comprise devices such as power switches (23a), (33a), with current sensing, associated to each one of the power loads (23), (33), which power switches (23a), (33a) are controlled from the corresponding microcontroller (20a), (30a) of the unit, and by comprising a step of sensing the output state of each one of said switches (23a), (33a), particularly their voltage or impedance, so that if the value sensed in a certain power switch (23a), (33a) exceeds a certain threshold, connection of the load (23), (33) associated therewith is not carried out.

19. A method according to claim 11, characterized in that in case that at completion of said short-circuit protection process by each one of said power distribution units (10, 20, 30) a short-circuit situation continues being sensed by the monitoring module, disconnection of the two batteries B1 and B2 from their corresponding network sectors is carried out.
